(19) United States
(12) Patent Application Publication
(10) Pub. No.: US 2012/0001714 A1
(43) Pub. Date: Jan. 5, 2012

(54) TRANSFORMER AND DISPLAY DEVICE HAVING THE SAME

(75) Inventors: Hwi Beom Shin, Jinju (KR); Geun Young Park, Suwon (KR); Sang Joon Seo, Suwon (KR); Young Min Lee, Suwon (KR); Jong Hae Kim, Suwon (KR)

(73) Assignee: SAMSUNG ELECTRO-MECHANICS CO., LTD.

(21) Appl. No.: 13/175,290

(22) Filed: Jul. 1, 2011

(30) Foreign Application Priority Data
Jul. 2, 2010 (KR) 10-2010-0063720

(51) Int. Cl. H01F 27/30

(52) U.S. Cl. 336/198

(57) ABSTRACT

The present invention relates to an LCD display device, a transformer, which can be applied to a thin display device, such as an LED display, and a display device having the same. There are provided a transformer including: a bobbin part including a primary bobbin including a first bobbin body having a first through hole therein, the first bobbin body including a first winding unit having a coil wound around an outer circumferential surface of the first through hole, and at least one secondary bobbin including a second bobbin body having a second through hole therein, the second bobbin body including a second winding unit having a coil wound around an outer circumferential surface of the second through hole, wherein the primary bobbin is inserted into the second through hole, and a protrusion is formed on at least part of the outer circumferential surface of the second through hole so that the protrusion is inserted into the first winding unit of the primary bobbin; and a core part having a pair of cores electromagnetically coupled with each other through the first through hole, and a display device having the same.

### CROSS-REFERENCE TO RELATED APPLICATIONS

This application claims the priority of Korean Patent Application No. 10-2010-0063720 filed on Jul. 2, 2010, in the Korean Intellectual Property Office, the disclosure of which is incorporated herein by reference.

### BACKGROUND OF THE INVENTION

1. Field of the Invention

The present invention relates to an LCD display device, and more particularly, to a transformer, which can be applied to a thin display device such as an LED display device, and a display device having the same.

2. Description of the Related Art

Recently, in the display industry, flat panel displays (FPDs) of utilizing new technologies have attracted attention as a substitute for cathode ray tubes (CRTs) since they are appropriate for high-resolution, large screen multimedia systems.

In particular, in the case of large displays, liquid crystal display TVs have gained attraction and are expected to receive wider attention in the future in terms of price and marketability.

Existing panel display TVs have used cold cathode fluorescent lamps (CCFLs) as backlight light sources. However, the use of light emitting diodes (LEDs) has gradually increased due to various kinds of advantages including low power consumption, long effective lifespan, and environmental friendliness.

As backlight units using LEDs have been reduced in cost and size, flat panel TVs have also been reduced in thickness, and the internal power of flat panel TVs has slimmed down.

A display device according to the related art includes a panel, a backlight unit supporting the panel, a circuit board supplying power to a light source of the backlight unit, a transformer mounted onto the circuit board and supplying the power to the circuit board, and a back cover coupled to the backlight unit and covering the circuit board and the transformer.

As a display device is gradually reduced in thickness, a back cover, formed of a conductive material, such as an iron plate, which can be reduced in size, has been used, instead of a back cover, made of thick plastic.

In addition, in order to reduce the thickness of the display device, the distance between the circuit board, mounted on the circuit board, and the back cover is gradually reduced.

In this situation, a reduction in distance between the transformer and the back cover may cause problems as follows.

First, the thickness of the transformer needs to be reduced in order to prevent a contact between the transformer and the back cover as the distance between the transformer and the back cover is reduced. However, in general, since transformers are manually manufactured, manufacturing costs are increased and productivity is decreased as a reduction in the thickness of transformers becomes greater.

Further, since the transformer and the back cover are positioned close to each other, magnetic flux is generated between the transformer and the back cover, and thus, the conductive back cover may consume power. That is, in the case in which the back cover is a conductive back cover, formed of an iron plate, the magnetic flux, generated by the transformer, is created by the back cover due to magnetic interference between the transformer of the circuit board and the conductive back cover. As a result, power consumption occurs as the back cover consumes power, thereby increasing the total power consumption and increasing the temperature of the transformer.

### SUMMARY OF THE INVENTION

An aspect of the present invention provides an LCD display device, a transformer, which can be applied to a thin display device, such as an LED display device, and a display device having the same.

According to an aspect of the present invention, there is provided a transformer including: a bobbin part including a primary bobbin including a first bobbin body having a first through hole therein, the first bobbin body including a first winding unit having a coil wound around an outer circumferential surface of the first through hole, and at least one secondary bobbin including a second bobbin body having a second through hole therein, the second bobbin body including a second winding unit having a coil wound around an outer circumferential surface of the second through hole, wherein the primary bobbin is inserted into the second through hole, and a protrusion is formed on at least part of the outer circumferential surface of the second through hole so that the protrusion is inserted into the first winding unit of the primary bobbin; and a core part having a pair of cores electromagnetically coupled with each other through the first through hole.

The transformer may further include a coil part including a primary coil wound around the first winding unit of the primary bobbin and at least one secondary coil wound around the first winding unit of the at least one secondary bobbin and having a predetermined turns ratio with respect to the primary coil.

The primary bobbin may include a first upper support unit and a first lower support unit individually supporting the coil while interposing the coil of the first winding unit therebetween.

The at least one secondary bobbin may include a second upper support unit and a second lower support unit individually supporting the coil while interposing the coil of the second winding unit therebetween.

The first upper support unit may be longer than the first lower support unit.

The second upper support unit may be longer than the second lower support unit.

The first lower support unit and the second lower support unit may have respective end portions being curved.

The first lower support unit and the second lower support unit may include respective end portions being curved convexedly from the first winding unit or the second winding unit toward outside.

The first lower support unit and the second lower support unit may include respective end portions being curved convexedly from outside toward the first winding unit or the second winding unit.

A cavity may be provided within each of the end portions of the first lower support unit and the second lower support unit.

The protrusion may include a first face extending toward a center of a through hole and a second face inclined from an end of the first face toward an outer circumferential surface of the through hole.

The protrusion may include first and second faces extending toward a center of a through hole and a third face connecting ends of the first and second faces.

The third face may be inclined from the end of the first face to the end of the second face.

The third face may be curved from the end of the first face to the end of the second face.

The protrusion may include a first face and a second face extending toward a center of a through hole, a third face extending from an end of the first face, and a fourth face extending from the end of the second face and connected to the third face.

The third face may be inclined from the end of the first face to the fourth face, and the fourth face may be inclined from the third face to the end of the second face.

The third face may be curved from the end of the first face to the fourth face.

The fourth face may be curved from the end of the third face to the end of the second face.

The protrusion may include first and second faces extending toward a center of a through hole, a third face extending from an end of the first face, a fourth face extending from an end of the second face, and a fifth face connecting an end of the third face and an end of the fourth face.

The fifth face may be disposed to be parallel with an outer circumferential surface of a through hole.

The third face may be curved from the end of the first face to the fifth face, and the fourth face may be curved from the end of the second face to the fifth face.

The bobbin part may include a plurality of secondary bobbins, and the plurality of secondary bobbins may include bobbin bodies having respective through holes therein, the bobbin bodies including respective winding units having coils wound around outer circumferential surfaces of the respective through holes, wherein the preceding secondary bobbins are received within the respective through holes, and protrusions are provided on at least parts of the outer circumferential surfaces of the respective through holes so that the protrusions may be inserted into the winding units of the preceding secondary bobbins.

According to another aspect of the present invention, there is provided a display device including: a panel; a backlight unit supporting the panel and including a light source; a circuit board supplying power to the light source included in the backlight unit; a transformer comprising a bobbin part including a primary bobbin including a first bobbin body having a first through hole therein, the first bobbin body including a first winding unit having a coil wound around an outer circumferential surface of the first through hole, and at least one secondary bobbin including a second bobbin body having a second through hole therein, the second bobbin body including a second winding unit having a coil wound around an outer circumferential surface of the second through hole, wherein the primary bobbin is inserted into the second through hole, and a protrusion is provided at least part of the outer circumferential surface of the second through hole so that the protrusion is inserted into the first winding unit of the primary bobbin, a core part having a pair of cores electromagnetically coupled with each other through the first through hole, the transformer mounted on the circuit board and supplying the power to the circuit board; and a back cover engaged with the backlight unit.

The display device may further include a coil part having a primary coil wound around the first winding unit of the primary bobbin and at least one secondary coil wound around the first winding unit of the at least one secondary bobbin and having a predetermined turns ratio with respect to the primary coil.

The primary bobbin may include a first upper support unit and a first lower support unit individually supporting the coil while interposing the coil of the first winding unit therebetween.

The at least one secondary bobbin may include a second upper support unit and a second lower support unit individually supporting the coil while interposing the coil of the second winding unit therebetween.

The first upper support unit may be longer than the first lower support unit.

The second upper support unit may be longer than the second lower support unit.

The first lower support unit and the second lower support unit may have respective end portions being curved.

The first lower support unit and the second lower support unit may include respective end portions being curved convexedly from the first winding unit or the second winding unit toward outside.

The first lower support unit and the second lower support unit may include respective end portions being curved convexedly from outside toward the first winding unit or the second winding unit.

A cavity may be provided within each of the end portions of the first lower support unit and the second lower support unit.

The protrusion may include a first face extending toward a center of a through hole and a second face inclined from an end of the first face toward an outer circumferential surface of the through hole.

The protrusion may include first and second faces extending toward a center of a through hole and a third face connecting ends of the first and second faces.

The third face may be inclined from the end of the first face to the end of the second face.

The third face may be curved from the end of the first face to the end of the second face.

The protrusion may include a first face and a second face extending toward a center of a through hole, a third face extending from an end of the first face, and a fourth face extending from the end of the second face and connected to the third face.

The third face may be inclined from the end of the first face to the fourth face, and the fourth face may be inclined from the third face to the end of the second face.

The third face may be curved from the end of the first face to the fourth face.

The fourth face may be curved from the end of the third face to the end of the second face.

The protrusion may include first and second faces extending toward a center of a through hole, a third face extending from an end of the first face, a fourth face extending from an end of the second face, and a fifth face connecting an end of the third face and an end of the fourth face.

The fifth face may be disposed to be parallel with an outer circumferential surface of a through hole.

The third face may be curved from the end of the first face to the fifth face, and the fourth face may be curved from the end of the second face to the fifth face.

The bobbin part may include a plurality of secondary bobbins, and the plurality of secondary bobbins may include bobbin bodies having respective through holes therein, the bobbin bodies including respective winding units having coils wound around outer circumferential surfaces of the respective through holes, wherein the preceding secondary bobbins are received within the respective through holes, and protrusions are provided on at least parts of the outer circumferential surfaces of the respective through holes so that the protrusions may be inserted into the winding units of the preceding secondary bobbins.

The circuit board may have a cavity therein, and the transformer may be at least partially received within the cavity.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view illustrating a transformer according to an exemplary embodiment of the present invention;

FIG. 2 is a perspective view illustrating a transformer in which bobbins are engaged with each other according to an exemplary embodiment of the present invention;

FIG. 3 is a cross-sectional view taken the direction A-A′ of the transformer of FIG. 2;

FIGS. 4A through 4C are views exemplifying a transformer in which bobbins are engaged with each other according to an exemplary embodiment of the present invention;

FIGS. 5A and 5B are partial enlarged views of FIG. 4;

FIGS. 5C and 5D are views illustrating a transformer according to an exemplary embodiment of the present invention;

FIGS. 6A and 6B are views exemplifying a transformer in which bobbins are engaged with each other in another manner according to an exemplary embodiment of the present invention;

FIGS. 7A and 7B are partial enlarged views of FIG. 6;

FIGS. 7C and 7D are views illustrating a transformer according to another exemplary embodiment of the present invention;

FIG. 8 is a display device using a transformer according to an exemplary embodiment of the present invention;

FIG. 9 is a cross-sectional view taken along the direction A-A′ of a display device according to an exemplary embodiment of the present invention; and

FIG. 10 is a view illustrating the electrical effects of a display device having a transformer according to an exemplary embodiment of the present invention.

### DETAILED DESCRIPTION OF THE PREFERRED EMBODIMENT

Exemplary embodiments of the present invention will now be described in detail with reference to the accompanying drawings.

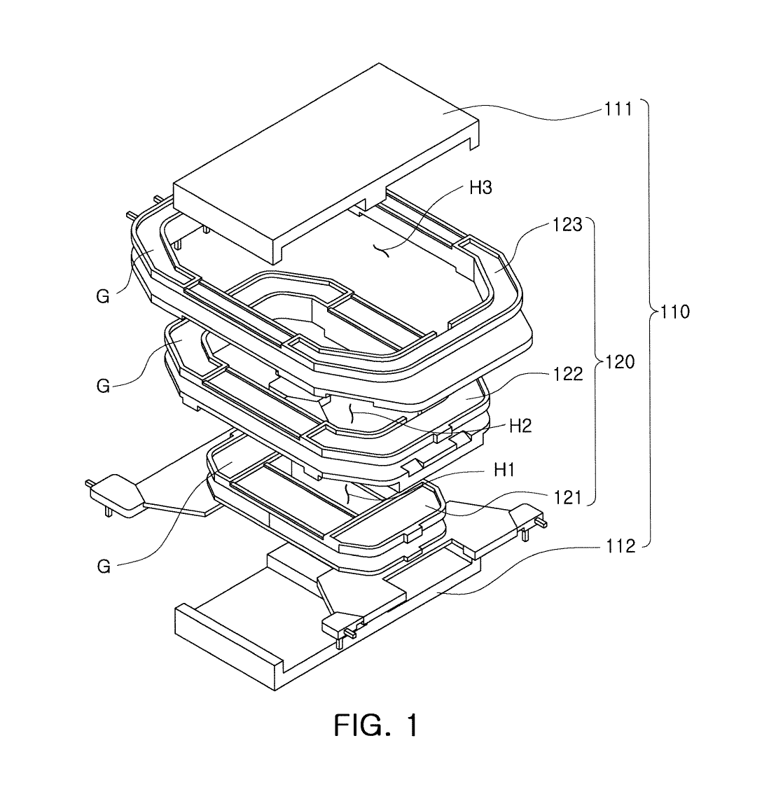

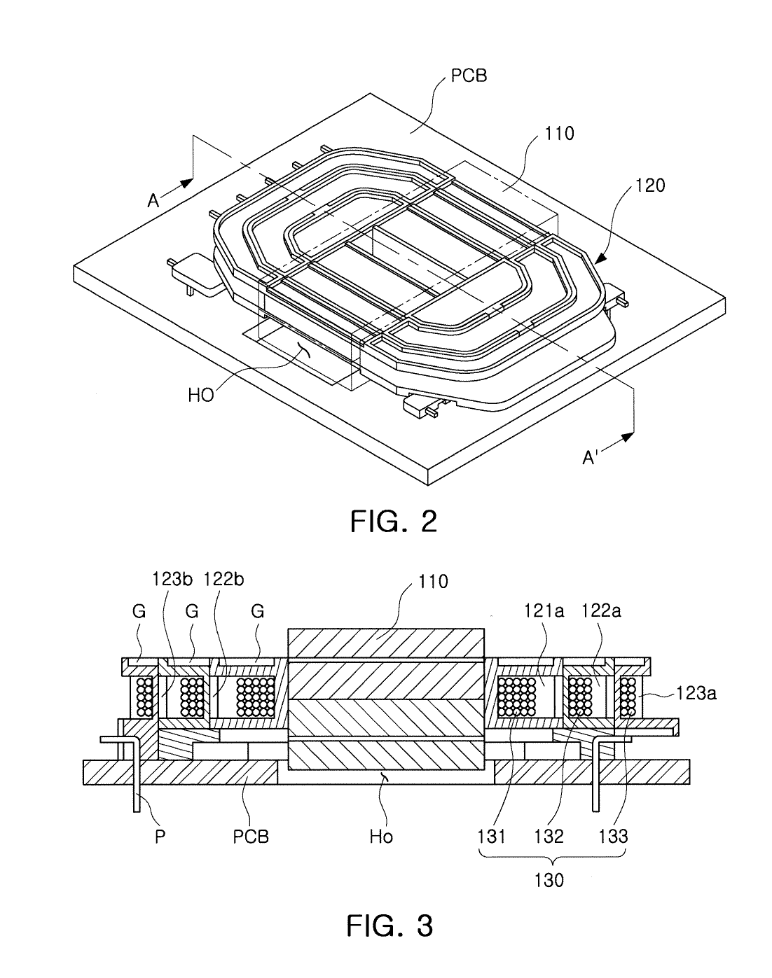

FIG. 1 is an exploded perspective view illustrating a transformer according to an exemplary embodiment of the invention. FIG. 2 is a perspective view illustrating a transformer in which bobbins are engaged with each other according to an exemplary embodiment of the invention. FIG. 3 is a cross-sectional view taken along the direction A-A′ of the transformation as shown in FIG. 2.

Referring to FIGS. 1 through 3, a transformer according to this embodiment may include a core part 110, a bobbin part 120, and a coil part 130.

The core part 110 may be formed by coupling EE cores and EI cores with each other and include a first core 111 and a second core 112 that are electromagnetically coupled through through holes in the bobbin part 120.

The bobbin part 120 may include a primary bobbin 121 and one or more secondary bobbins 122 and 123. The one or more secondary bobbins 122 and 123 may have a first secondary bobbin 122 and a second secondary bobbin 123. Alternatively, though not shown in the drawings, the one or more secondary bobbins 122 and 123 may have a plurality of secondary bobbins.

The primary bobbin 121 may have a first bobbin body, which may have a first through hole H1 therein. The first core 111 and the second core 112 of the core part 110 may at least be electromagnetically coupled with each other through the first through hole H1.

The primary bobbin 121 may include a first winding unit 121a having a coil wound around an outer circumferential surface of the first through hole H1. A primary coil 131 may be wound around the first winding unit 121a. The primary bobbin 121 may be inserted into a second through hole H2 of the first secondary bobbin 122. The first winding unit 121a of the primary bobbin 121 may be inserted into an outer circumferential surface of the second through hole H2 of the first secondary bobbin 122 to thereby form a first protrusion 122b that engages the primary bobbin 121 and the first secondary bobbin 122 with each other.

That is, the first secondary bobbin 122 may have a second bobbin body, which may have the second through hole H2 therein. The primary bobbin 121 may be inserted into the second through hole H2, so that the first secondary bobbin 122 and the primary bobbin 121 may be engaged with each other. The first protrusion 122b for engagement may be formed on the outer circumferential surface of the second through hole H2 of the first secondary bobbin 122. The first protrusion 122b may be inserted into the first winding unit 121a of the primary bobbin 121. The first secondary bobbin 122 may include a second winding unit 122a having a first secondary coil 132 wound around the outer circumferential surface of the second through hole H2.

In the same manner, the second secondary bobbin 123 may be included in the bobbin part 120, the second secondary bobbin 123 may have a third bobbin body, and the third bobbin body may have a third through hole H3 therein. The first secondary bobbin 122 may be inserted into the third through hole H3, so that the second secondary bobbin 123 and the first secondary bobbin 122 may be engaged with each other. A second protrusion 123b for engagement may be formed on an outer circumferential surface of the third through hole H3 of the second secondary bobbin 123. The second protrusion 123b may be inserted into the second winding unit 122a of the first secondary bobbin 122. The second secondary bobbin 123 may include a tertiary winding unit 123a having a second secondary coil 133 wound around the outer circumferential surface of the third through hole H3.

The coil part 130 may have a primary coil 131 and at least one or more secondary coils 132 and 133 that are wound around the first winding unit 121a of the primary bobbin 121. The number of at least one or more secondary coils 132 and 133 may correspond to the number of secondary bobbins included in the one or more secondary bobbins 122 and 123. That is, when the first secondary bobbin 122 is provided, the first secondary coil 132 may be wound around the second winding unit 122a. When the secondary bobbins 122 and 123 are provided, the first secondary coil 132 may be wound around the second winding unit 122a, and the second secondary coil 133 may be wound around the tertiary winding unit 123a.

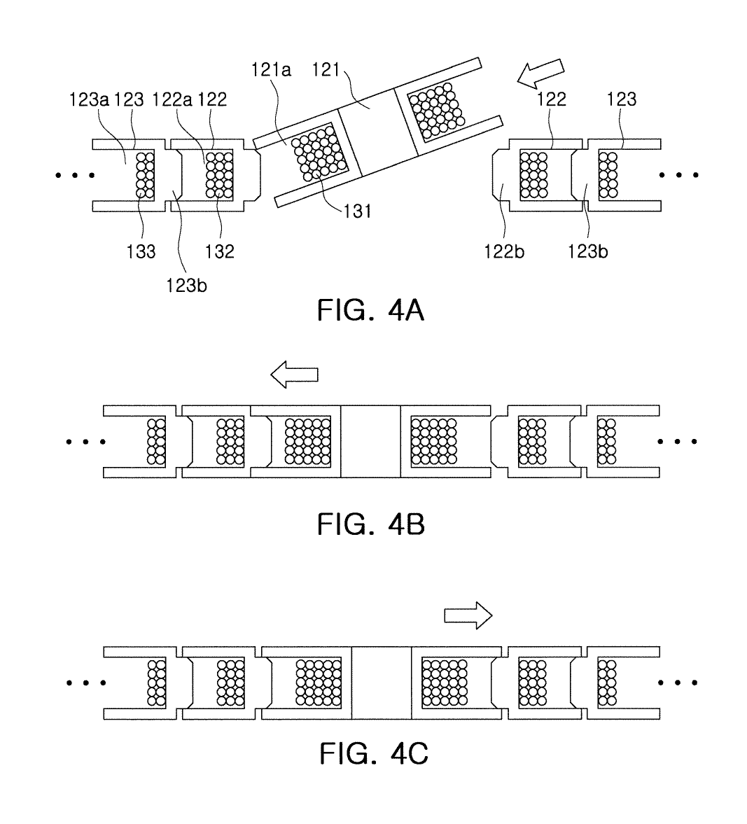

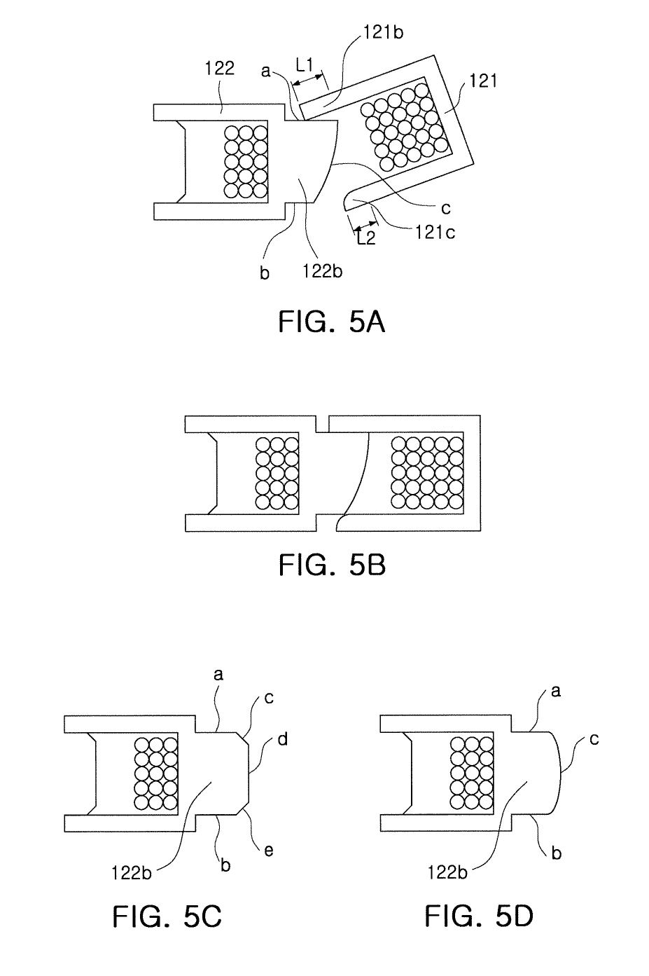

FIGS. 4A through 4C are views exemplifying a transformer in which bobbins are engaged with each other according to an exemplary embodiment of the invention. FIGS. 5A and 5B are partial enlarged views of FIG. 4, and FIGS. 5C and 5D are views illustrating a transformer according to an exemplary embodiment of the invention.

Referring to FIGS. 4 and 5, a transformer according to this embodiment may have a plurality of bobbins engaged with each other through holes. Referring to FIGS. 4A through 4C, the first secondary bobbin 122 may be inserted into the through hole of the second secondary bobbin 123, and the primary bobbin 121 may be inserted into the through hole of the first secondary bobbin 122. Here, the primary bobbin 121 may be inserted into the through hole of the first secondary bobbin 122 at an angle, so that one side of the primary bobbin 121 may be engaged with the first protrusion 122b of the first secondary bobbin 122, while the other side of the primary bobbin 121 may be engaged with the first protrusion 122b of the first secondary bobbin 122.

Here, support units, used to support coils wound around winding units, may be formed. These support units may have an upper support unit and a lower support unit. Meanwhile, referring to FIG. 1, recesses G may be formed in the support units in order to satisfy an insulating distance between primary and secondary bobbins.

Referring to FIGS. 5A through 5D, for example, the primary bobbin 121 may include a first upper support unit 121b and a second lower support unit 121c. As shown in FIG. 5B, for the smooth engagement of the primary bobbin 121, a length L2 of an end portion of the second lower support unit 121C may be smaller than a length L1 of an end portion of the first upper support unit 121b. Furthermore, for the smooth engagement thereof, the end portion of the first lower support unit may be curved. More specifically, the end portion thereof may be curved convexedly upward.

The first protrusion 122b of the first secondary bobbin 122 is inserted into the first winding unit 121a of the primary bobbin 121, so that the primary bobbin 121 and the first secondary bobbin 122 can be engaged with each other as shown in FIG. 5B.

As shown in FIG. 5A, the first protrusion 122b may have a first face a, a second face b, and a third face c along the outer circumferential surface of the second through hole H2. Namely, the first protrusion 122b includes the first face a and the second face b extending from the outer circumferential surface of the second through hole H2 toward the center of the second through hole H2, and the third face c to which the end, facing the center of the second through hole H2, of the first face a is connected, so the section of the first protrusion 121a may substantially have the shape of trapezoid. In more detail, the first face a and the second face b may be disposed to be parallel with each other and extend from the outer circumferential surface of the second through hole H2 toward the first winding unit 121a, while the third face c may be connected from the end of the second face b to the end of the first face a, be inclined, and be curved convex.

Furthermore, as shown in FIG. 5D, the third face c of the first protrusion 122b may be curved convexedly toward the first winding unit 121a. As shown in FIG. 5C, the first protrusion 122b may have a first face a, a second face b, a third face c, a fourth face d, and a fifth face e along the outer circumferential surface of the second through hole H2. Namely, the first protrusion 122b has a first face a and second face b extending toward the center of the second through hole H2 from an outer circumferential surface of the second through hole H2, a third face c extending from the end, facing the center of the second through hole H2, of the first face a, a fourth face d extending from the end, facing the center of the second through hole H2, of the second face b, and a fifth face e having one end connected to an end, the opposite to one surface connected to the first face a, of the third face c and the other end connected to an end, the opposite to one surface connected to the second face b, of the fourth face d, so the first protrusion 122b may have a substantially hexagonal sectional shape. In more detail, the first face a and the second face b may be disposed to be parallel with each other and extend from the outer circumferential surface of the second through hole H2 toward the first winding unit 121a. The third face c may be inclined downwardly from the end of the first face a, the fourth face d may be inclined upwardly from the end of the second face b, and the fifth face e may connect the end of the third face c and the end of the fourth face d.

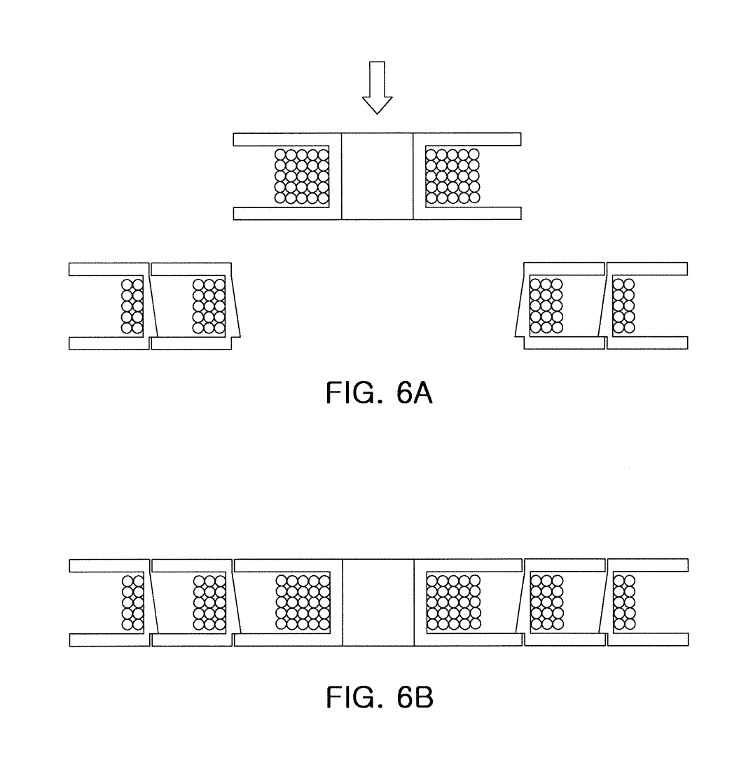

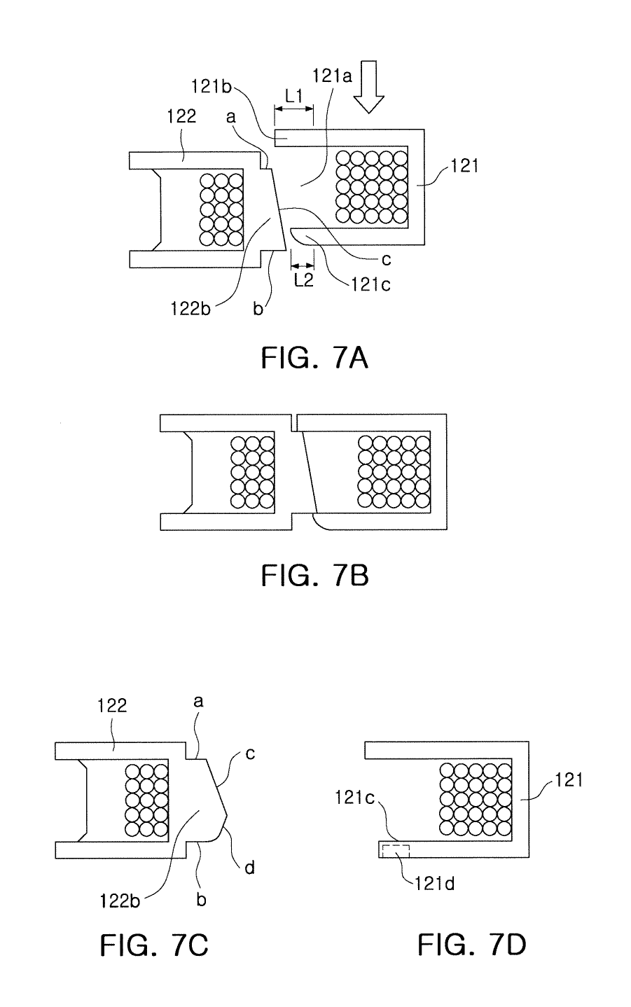

FIGS. 6A and 6B are views exemplifying a transformer in which bobbins are engaged with each other according to an exemplary embodiment of the invention. FIGS. 7A and 7B are partial enlarged views of FIG. 6. FIGS. 7C and 7D are views illustrating a transformer according to another exemplary embodiment of the invention.

Referring to FIGS. 6 and 7, a transformer according to this embodiment may have a plurality of bobbins engaged with each other through holes. Referring to FIGS. 6A and 6B, the first secondary bobbin 122 may be inserted into the through hole of the second secondary bobbin 123, and the primary bobbin 121 may be inserted into the through hole of the first secondary bobbin 122. Here, the primary bobbin 121 may be inserted into the through hole of the first secondary bobbin 122 at a time by a force being applied from top to bottom.

The foregoing combination may be formed as the winding unit and the protrusion, and the protrusion may have a first face extending toward the center of the through hole from an outer circumferential surface of the through hole and a second face inclined to the outer circumferential surface of the through hole from the end facing the center of the through hole, substantially having a triangular section.

Referring to FIG. 7A, for example, the primary bobbin 121 may include the first upper support unit 121b and the second lower support unit 121c. As shown in FIG. 7B, for the smooth engagement of the primary bobbin 121, the length L2 of the end portion of the second lower support unit 121C may be smaller than the length L1 of the end portion of the first upper support unit 121b. Furthermore, for the smooth engagement thereof, the end portion of the second lower support unit may be curved. Specifically, the end portion thereof may be curved convexedly downward. Furthermore, as shown in FIG. 7D, a cavity 121d may be formed in order to exert an elastic force to the second lower support unit 121c.

As shown in FIG. 7A, the first protrusion 122b may have a first face a, a second face b, and a third face c along the outer circumferential surface of the second through hole H2. The first face a and the second face b may be disposed to be parallel with each other and extend from the outer circumferential surface of the second through hole H2 toward the first winding unit 121a. The third face c connects the end of the first face a and the end of the second face b and may be inclined. Furthermore, as shown in FIG. 7C, the first protrusion 122b may have a first face a, a second face b, a third face c, and a fourth face d along the outer circumferential surface of the second through hole H2. The first protrusion 122b has the first face a and the second face b extending toward the center of the through hole H2 from the outer circumferential surface of the through hole H2, the third face c extending from the end, facing the center of the through hole H2, of the first face a, and the fourth face d extending from the end, facing the center of the through hole H2, of the second face b, and connected to one end of the third face c, so the first protrusion 122b may have a substantially pentagonal sectional shape. In detail, the first face a and the second face b may be disposed to be parallel with each other and extend from the outer circumferential surface of the second through hole H2 toward the first winding unit 121a, the third face c may be inclined from the end of the first face a, and the fourth face d may connect the end of the second face b and the end of the third face c and be curved convexedly.

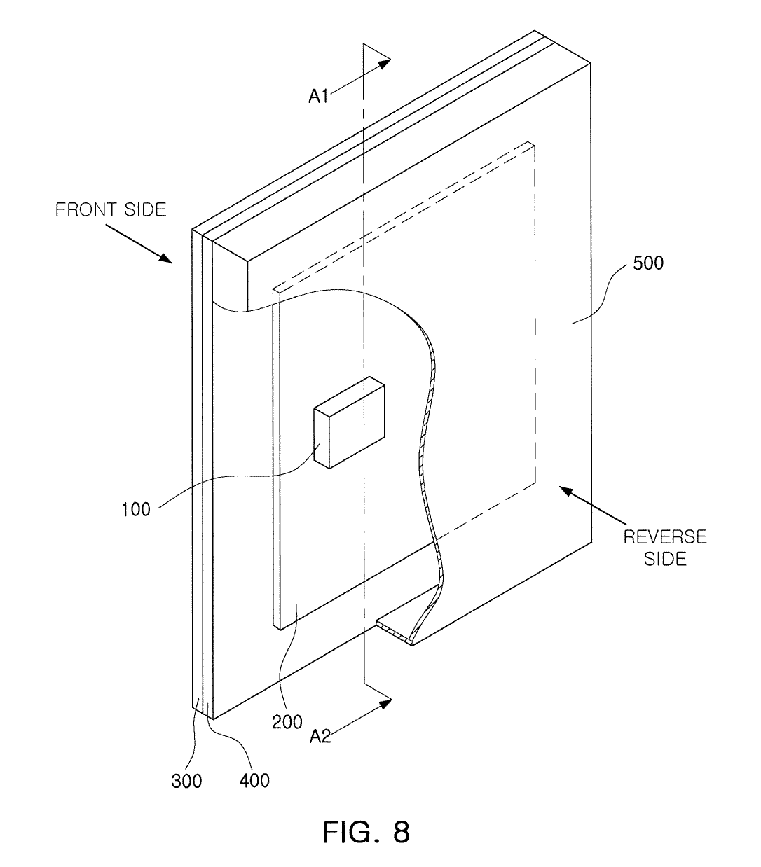

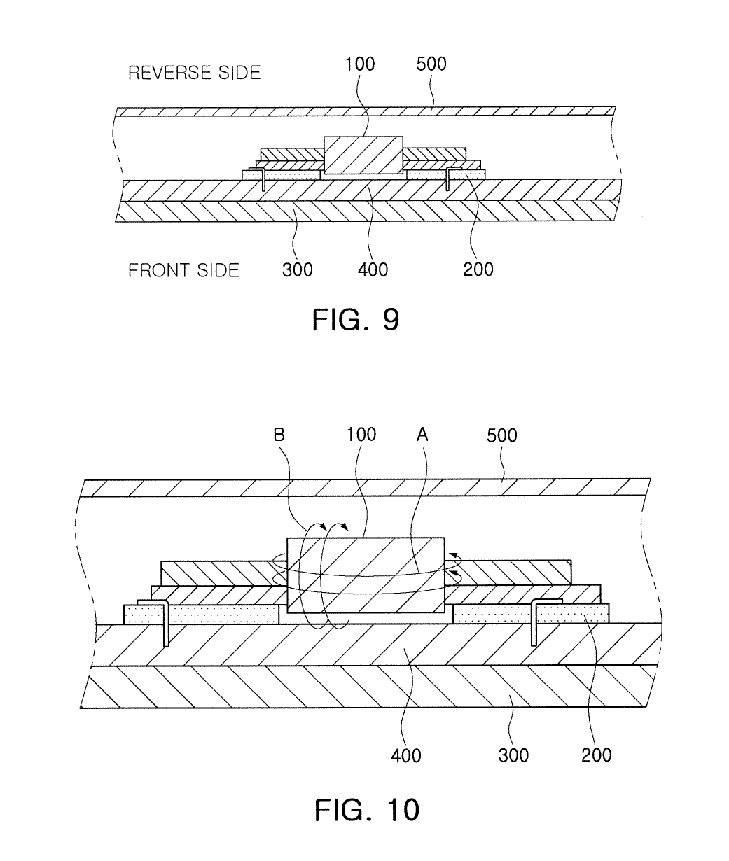

FIG. 8 is a display device using a transformer according to an exemplary embodiment of the invention. FIG. 9 is a cross-sectional view taken along the direction A-A′ of a display device according to an exemplary embodiment of the invention.

Referring to FIG. 8, a display device using a transformer according to an exemplary embodiment of the invention may include a panel 300, a backlight unit 400 supporting the panel 300 and including a light source, a circuit board 200 supplying power to a light source included in the backlight unit 400, the transformer 100 supplying the power to the circuit board 200, and a back cover 500 to be engaged with the backlight unit 400.

The panel 300 maybe an LCD panel. However, the present invention is not limited thereto.

For example, when panel 300 is composed of an LCD panel, the backlight unit 400 may include a lamp, which serves as the light source, a light guide panel, a plurality of sheets, a lamp reflector, and a mold frame (or a support main).

Here, the plurality of sheets may include reflection sheets, diffusion sheets, prism sheets, and protection sheets.

Meanwhile, as for the light source of the backlight unit 400, a light emitting diode (LED) may be used. In addition to the transformer 100, power devices, power components, and power-related circuits, which are necessary to supply power to a display device according to an exemplary embodiment of the invention, may be provided on the circuit board 200.

Referring to FIGS. 3 and 9, a cavity HO may be formed in the circuit board 200 so that at least part of the transformer 100 may be received within the cavity HO. The core part 110 of the transformer 100 may be partially received within the cavity HO and may transmit and receive power to the circuit board 200 through pins of the bobbin part 120 and be fixed thereto.

FIG. 10 is a view illustrating the electrical effects of a display device using a transformer according to an exemplary embodiment of the invention.

Referring to FIG. 10, the transformer 100 according to this embodiment generates magnetic flux in a direction indicated by a reference character B, so that a direction of currents may be determined as indicated by a reference character A, thereby reducing electromagnetic interference between the transformer 100 and the back cover 500. Therefore, a separate shielding device may not be used.

As set forth above, according to exemplary embodiments of the invention, a thin transformer may be configured to have a plurality bobbins engaged with each other, thereby achieving the automation of transformers. A transformer being manufactured in this manner is used in a thin display device to thereby remove electromagnetic interference between the transformer and a case of the display device. As a result, a separate shielding device is not used, so that manufacturing costs are reduced, and a more reduction in thickness of the display device can be achieved.

While the present invention has been shown and described in connection with the exemplary embodiments, it will be apparent to those skilled in the art that modifications and variations can be made without departing from the spirit and scope of the invention as defined by the appended claims.

What is claimed is:

1. A transformer comprising:
a bobbin part comprising a primary bobbin including a first bobbin body having a first through hole therein, the first bobbin body including a first winding unit having a coil wound around an outer circumferential surface of the first through hole, and at least one secondary bobbin comprising a second bobbin body having a second through hole therein, the second bobbin body including a second winding unit having a coil wound around an outer circumferential surface of the second through hole, wherein the primary bobbin is inserted into the second through hole, and a protrusion is formed on at least part of the outer circumferential surface of the second through hole so that the protrusion is inserted into the first winding unit of the primary bobbin; and
a core part having a pair of cores electromagnetically coupled with each other through the first through hole.

2. The transformer of claim 1, further comprising a coil part comprising a primary coil wound around the first winding unit of the primary bobbin and at least one secondary coil wound around the first winding unit of the at least one secondary bobbin and having a predetermined turns ratio with respect to the primary coil.

3. The transformer of claim 1, wherein the primary bobbin comprises a first upper support unit and a first lower support unit individually supporting the coil while interposing the coil of the first winding unit therebetween.

4. The transformer of claim 3, wherein the at least one secondary bobbin comprises a second upper support unit and a second lower support unit individually supporting the coil while interposing the coil of the second winding unit therebetween.

5. The transformer of claim 4, wherein the first upper support unit is longer than the first lower support unit.

6. The transformer of claim 5, wherein the second upper support unit is longer than the second lower support unit.

7. The transformer of claim 6, wherein the first lower support unit and the second lower support unit have respective end portions being curved.

8. The transformer of claim 7, wherein the first lower support unit and the second lower support unit comprise respective end portions being curved convexedly from the first winding unit or the second winding unit toward outside.

9. The transformer of claim 7, wherein the first lower support unit and the second lower support unit comprise respective end portions being curved convexedly from outside toward the first winding unit or the second winding unit.

10. The transformer of claim 6, wherein a cavity is provided within each of the end portions of the first lower support unit and the second lower support unit.

11. The transformer of claim 1, wherein the protrusion comprises a first face extending toward a center of a through hole and a second face inclined from an end of the first face toward an outer circumferential surface of the through hole.

12. The transformer of claim 1, wherein the protrusion comprises first and second faces extending toward a center of a through hole and a third face connecting ends of the first and second faces.

13. The transformer of claim 12, wherein the third face is inclined from the end of the first face to the end of the second face.

14. The transformer of claim 12, wherein the third face is curved from the end of the first face to the end of the second face.

15. The transformer of claim 1, wherein the protrusion comprises a first face and a second face extending toward a center of a through hole, a third face extending from an end of the first face, and a fourth face extending from the end of the second face and connected to the third face.

16. The transformer of claim 15, wherein the third face is inclined from the end of the first face to the fourth face, and the fourth face is inclined from the third face to the end of the second face.

17. The transformer of claim 16, wherein the third face is curved from the end of the first face to the fourth face.

18. The transformer of claim 16, wherein the fourth face is curved from the end of the third face to the end of the second face.

19. The transformer of claim 1, wherein the protrusion comprises first and second faces extending toward a center of a through hole, a third face extending from an end of the first face, a fourth face extending from an end of the second face, and a fifth face connecting an end of the third face and an end of the fourth face.

20. The transformer of claim 19, wherein the fifth face is in parallel with an outer circumferential surface of a through hole.

21. The transformer of claim 20, wherein the third face is curved from the end of the first face to the fifth face, and
the fourth face is curved from the end of the second face to the fifth face.

22. The transformer of claim 1, wherein the bobbin part comprises a plurality of secondary bobbins, and
the plurality of secondary bobbins comprise bobbin bodies having respective through holes therein, the bobbin bodies including respective winding units having coils wound around outer circumferential surfaces of the respective through holes,
wherein the preceding secondary bobbins are received within the respective through holes, and protrusions are provided on at least parts of the outer circumferential surfaces of the respective through holes so that the protrusions may be inserted into the winding units of the preceding secondary bobbins.

23. A display device comprising:
a panel;
a backlight unit supporting the panel and including a light source;
a circuit board supplying power to the light source included in the backlight unit;
a transformer comprising a bobbin part including a primary bobbin including a first bobbin body having a first through hole therein, the first bobbin body including a first winding unit having a coil wound around an outer circumferential surface of the first through hole, and at least one secondary bobbin comprising a second bobbin body having a second through hole therein, the second bobbin body including a second winding unit having a coil wound around an outer circumferential surface of the second through hole, wherein the primary bobbin is inserted into the second through hole, and a protrusion is provided at least part of the outer circumferential surface of the second through hole so that the protrusion is inserted into the first winding unit of the primary bobbin, a core part having a pair of cores electromagnetically coupled with each other through the first through hole, the transformer mounted on the circuit board and supplying the power to the circuit board; and
a back cover engaged with the backlight unit.

24. The display device of claim 23, further comprising a coil part having a primary coil wound around the first winding unit of the primary bobbin and at least one secondary coil wound around the first winding unit of the at least one secondary bobbin and having a predetermined turns ratio with respect to the primary coil.

25. The display device of claim 23, wherein the primary bobbin comprises a first upper support unit and a first lower support unit individually supporting the coil while interposing the coil of the first winding unit therebetween.

26. The display device of claim 25, wherein the at least one secondary bobbin comprises a second upper support unit and a second lower support unit individually supporting the coil while interposing the coil of the second winding unit therebetween.

27. The display device of claim 26, wherein the first upper support unit is longer than the first lower support unit.

28. The display device of claim 27, wherein the second upper support unit is longer than the second lower support unit.

29. The display device of claim 28, wherein the first lower support unit and the second lower support unit have respective end portions being curved.

30. The display device of claim 29, wherein the first lower support unit and the second lower support unit comprise respective end portions being curved convexedly from the first winding unit or the second winding unit toward outside.

31. The display device of claim 29, wherein the first lower support unit and the second lower support unit comprise respective end portions being curved convexedly from outside toward the first winding unit or the second winding unit.

32. The display device of claim 28, wherein a cavity is provided within each of the end portions of the first lower support unit and the second lower support unit.

33. The display device of claim 23, wherein the protrusion comprises a first face extending toward a center of a through hole and a second face inclined from an end of the first face toward an outer circumferential surface of the through hole.

34. The display device of claim 23, wherein the protrusion comprises first and second faces extending toward a center of a through hole and a third face connecting ends of the first and second faces.

35. The display device of claim 34, wherein the third face is inclined from the end of the first face to the end of the second face.

36. The display device of claim 34, wherein the third face is curved from the end of the first face to the end of the second face.

37. The display device of claim 23, wherein the protrusion comprises a first face and a second face extending toward a center of a through hole, a third face extending from an end of the first face, and a fourth face extending from the end of the second face and connected to the third face.

38. The display device of claim 37, wherein the third face is inclined from the end of the first face to the fourth face, and the fourth face is inclined from the third face to the end of the second face.

39. The display device of claim 38, wherein the third face is curved from the end of the first face to the fourth face.

40. The display device of claim 38, wherein the fourth face is curved from the end of the third face to the end of the second face.

41. The display device of claim 23, wherein the protrusion comprises first and second faces extending toward a center of a through hole, a third face extending from an end of the first face, a fourth face extending from an end of the second face, and a fifth face connecting an end of the third face and an end of the fourth face.

42. The display device of claim 41, wherein the fifth face is in parallel with an outer circumferential surface of a through hole.

43. The display device of claim 42, wherein the third face is curved from the end of the first face to the fifth face, and
the fourth face is curved from the end of the second face to the fifth face.

44. The display device of claim 23, wherein the bobbin part comprises a plurality of secondary bobbins, and
the plurality of secondary bobbins comprise bobbin bodies having respective through holes therein, the bobbin bodies including respective winding units having coils wound around outer circumferential surfaces of the respective through holes,
wherein the preceding secondary bobbins are received within the respective through holes, and protrusions are provided on at least parts of the outer circumferential surfaces of the respective through holes so that the protrusions may be inserted into the winding units of the preceding secondary bobbins.

45. The display device of claim 23, wherein the circuit board has a cavity therein, and
the transformer is at least partially received within the cavity.
